(19) United States
(12) Patent Application Publication
(10) Pub. No.: US 2011/0084594 A1
(43) Pub. Date: Apr. 14, 2011

(54) PHOSPHORS, FABRICATING METHOD THEREOF, AND LIGHT EMITTING DEVICES EMPLOYING THE SAME

(75) Inventors: Shian-Jy Wang, Hsinchu County (TW); Shyue-Ming Jang, Hsinchu City (TW); Yi-Chen Chiu, Hsinchu City (TW); Wei-Jen Liu, Taoyuan City (TW); Teng-Ming Chen, Hsinchu City (TW); Chien-Hao Huang, Yunlin County (TW); Yao-Tsung Yeh, Taoyuan City (TW)

(73) Assignee: INDUSTRIAL TECHNOLOGY RESEARCH INSTITUTE, Hsinchu County (TW)

(21) Appl. No.: 12/705,728

(22) Filed: Feb. 15, 2010

(30) Foreign Application Priority Data
Oct. 12, 2009 (TW) 098134483

(51) Int. Cl. C09K 11/70; C09K 11/54; H01J 1/62; H01J 61/44

(52) U.S. Cl. 313/487; 252/301.4 P; 252/301.6 P; 313/483; 313/503; 313/486

(57) ABSTRACT

The invention provides a phosphor emitting UV and visible light, which may be collocated with other phosphors to provide a white light illumination device, composed of

(M₁₋ₓREₓ)₉M′(PO₄)₇ or M₉(M′_{1-y}RE′_{y})(PO₄)₇
, wherein M is Mg, Ca, Sr, Ba, Zn or combinations thereof, M′ is Sc, Y, La, Gd, Al, Ga, In or combinations thereof, RE is Pr, Nd, Eu, Gd, Tb, Ce, Dy, Yb, Er, Sc, Mn, Zn or combinations thereof, RE′ is Pr, Nd, Gd, Tb, Ce, Dy, Yb, Er, Bi or combinations thereof, 0.001≦x≦0.8, and 0.001≦y<1.0.

### CROSS REFERENCE TO RELATED APPLICATIONS

This application is based upon and claims the benefit of priority from the prior Taiwan Patent Application No. 098134483, filed on Oct. 12, 2009, the entire contents of which are incorporated herein by reference.

### BACKGROUND OF THE INVENTION

1. Field of the Invention

The present invention relates to a phosphor, and in particular relates to a light emitting device employing the same.

2. Description of the Related Art

Conventional white light illumination devices such as tungsten lamps or fluorescent lamps have been gradually replaced by light emitting diodes (herein referred to as LEDs). LEDs have the following advantages: (1) suitable for use in array packages due to its small size, thus convenient for collocating with different colors; (2) a long operating lifespan of more than 10,000 hours, which is 50 times that of conventional tungsten lamps; (3) durability and shock resistant due to transparent packaging resins; (4) environmentally friendly as its interior structure is free of mercury, decreasing pollution and waste management; and (5) energy savings due to low power consumption, as power consumption or LEDs is ⅓ to ⅕ that of conventional tungsten lamps.

Generally, white light is a mixture of at least one colored light. For example, the white light seen by a human eye can be formed by mixing blue and yellow lights or mixing blue, green, and red lights. The former is a two-wavelength white light, and the latter is three-wavelength white light.

The three most common commercially available semiconductor white light devices are described as follows. The first is a white illumination device collocated by red, green, and blue LED chips. This white light module has high luminescence efficiency and high color rendering. However, the different colored LED chips require different epitaxial materials, wherein different electrical voltages are needed. Accordingly, the manufacturing cost is high, the circuit layout is complicated, and the appropriate mixing of different colored lights is difficult.

The second is a white illumination device disclosed by Nichia Corporation. The most common version is the white light formed by a yellow YAG phosphor excited by a blue LED. The periphery of the blue LED is filled with optical gel sealing the yellow YAG phosphor. The blue LED emits a blue light having a wavelength of about 400 nm to 530 nm. The yellow YAG phosphor is excited by a part of the blue light and then emits a yellow light. The remaining part of the blue light collocates with the yellow light to form a two-wavelength white light.

The described two-wavelength (blue and yellow) white LED has many illumination limitations. Specifically, for the two-wavelength white light, the color temperature is usually high and the illuminated color is not uniform. Therefore, the collocation of the blue light and the yellow phosphor is required additionally to improve color quality. Next, because a blue light wavelength from an LED chip will change along with different temperatures, the color control of the white light is difficult. In addition, the two-wavelength white light lacks red light, thereby reducing color rendering.

The third white illumination device is formed by blue, green, and red phosphors evenly dispersed in optical resin. By excitation, the phosphors emit red, green, and blue lights which further collocate to provide a three-wavelength white light. Although the luminescence efficiency thereof is relatively low, the three-wavelength white light has high color rendering. Manufacturing flexibility and illumination properties of the third white illumination device is comparably better than the first and second commonly found white illumination devices.

Please refer to Table 1, showing conventional phosphate phosphors as disclosed in related patents.

TABLE 1

| Patent No. | Phosphors |
|---|---|
| U.S. Pat. No. | (Ca_{1-x-y-p-q}SrₓBa_{y}Mg_{z}EuₚMn_{q})ₐ (PO₄)₃D; |
| 6,616,862 B2 | D = F, Cl, OH; 0 ≦ x ≦ 1, 0 ≦ y ≦ 1, 0 ≦ z ≦1, 0 ≦ p ≦ 0.3, |
| | 0 < q ≦ 0.3, 0 < x + y + z + p + q ≦ 1, 4.5 ≦ a ≦ 5 |
| U.S. Pat. No. | (Ca_{1-x-y}MnₓSb_{y})₅ (PO₄)₃(F_{1-z-y}Cl_{z}O_{y}); 0 < x < 0.05, |
| 7,255,812 B2 | 0.004 < y < 0.01, 0 < z < 0.1 |
| U.S. Pat. No. | Ca_{2-w-x-y-z}SrₓA_{y}Pr_{z}P₂O₇; A = Na⁺ 0 ≦ w ≦ 0.1, |
| 7,396,491 B2 | 0 ≦ x ≦ 2 − w − y − z, 0 ≦ y ≦ 0.25, 0 ≦ z ≦ 0.12 |
| US 2008/0233034 A1 | LiₓZn₁₋ₓPO₄: Mₓ; 0 ≦ x ≦ 1, M = V, Cr, Mn, Fe, |
| | Cu, Nb, Mo, Ru, Ag, Ta, W, Os, Ir, Pt, Au |
| U.S. Pat. No. | (Ln₁₋ₓMₓ)₃PO₇; (Ln₁₋ₓMₓ)₃ PO₇ · aMg₃(PO₄)₂; |
| 5,156,764 | M = Tb, Eu, Sm, Tm, Dy, Pr Ln = Y, Gd, |
| | La, Lu; 0.0001 ≦ x ≦ 0.5 |
| U.S. Pat. No. | La_{1-x-y-z}CeₓTb_{y}Gd_{z}PO₄; |
| 5,154,852 | 0.2 ≦ x ≦0.45, 0.127 ≦ y ≦ 0.137, 0.001 ≦ z ≦ 0.1 |
| U.S. Pat. No. | Ln_{1-x-y-z}CeₓTb_{y}PO₄ · zM Ln = Y, La, Gd; |
| 5,422,040 | M = B₂O₃, Al₂O₃, In₂O₃, ZrO₂, Nb₂O₅, TiO₂ |
| | 0.05 ≦ x ≦ 0.7, 0.05 ≦ y ≦ 0.4, 0.01 ≦ z ≦ 0.1 |
| U.S. Pat. No. | Y_{1-x-y}CeₓPr_{y}PO₄; |
| 7,497,974 B2 | 0.01 ≦ x ≦ 0.2, 0.001 ≦ y ≦ 0.05 |
| WO 00/01784 | La_{1-x-y-z}TmₓLi_{y}Sr_{z}PO₄ |
| | 0.001 ≦ x ≦ 0.05, 0.01 ≦ y ≦ 0.05, 0 ≦ z ≦ 0.05 |
| U.S. Pat. No. | (R_{1-x-y-z}GdₓM_{y})₃(PO₄)_{(2+x-y)z} |
| 4,222,890 | R = Mg, Ca, Sr, Ba, Zn; |
| | M = Tl, Ag, Li, Na, K, Rb, Cs |
| | 0.005 ≦ x ≦ 0.35, 0 ≦ y ≦ 0.3, 0.7 ≦ z ≦ 1.9 |
| DE 1572221 | (Y + Gd)₂O₃ · (1 − x)V₂O₅ · x(As + P)₂O₅: pEu₂O₃; |
| | 0.1 < x < 0.8, 0.02 < p < 0.18 |
| CN 101054519 A | Ca₄₍₁₋ₓ₎O(PO₄)₂: xEu²⁺ |
| | x = 0.01~10% |
| U.S. Pat. No. | (La_{1-x-y}CeₓTb_{y})mBO₃ · nPO₄ |
| 4,764,301 | 0.15 ≦ x ≦ 0.45, 0.1 ≦ y ≦ 0.2, 0.01 ≦ m/(m + n) ≦ 0.045 |
| U.S. Pat. No. | (Y₁₋ₓ Gdₓ)₂O₃ · A; |
| 3,542,690 | A = P₂O₅, B₂O₃, 2GeO₂, 0.002 ≦ x ≦ 0.1 |
| JP 2005220353 | (La_{1-x-y-z-u-v}TbₓCe_{y}Gd_{z}DᵤEᵥ)(P_{1-q}B_{q})O₄ |
| | D = Pr, Nd, Sm, Eu, Dy, Ho, Er, Tm, Yb; |
| | E = Sc, Y, Lu; x = 0.005~0.3, y = 0.005~0.2, |
| | z = 0.3~0.9, u = 10⁻⁹~0.1, v = 10⁻⁹~0.2, 0 ≦ q < 1, |
| | 0 < x + y + z + u + v < 1 |
| NL7003248 | M₁₋ₓEuₓV_{1-y-z}P_{y}M′_{z}O₄ |
| | M = Y, Gd, M′ = Ta, Nb x = 0.01~0.08, 0 < y ≦ 0.5, |
| | 0 < z ≦ 0.015 |
| CA 517680 | M₃(PO₄)₂: xSn; M = Ca, Sr, Ba |
| | x = 0.002~0.2 |
| CA 504902 | Ca₃(PO₄)₂: xSn, yMn x = 0.002~0.2, |
| | 0 < y < 0.2 |
| CA 780307 | MThP₂O₈; M = Ca, Mg, Zn MM′Th₂P₄O₁₆; |
| | as M = Zn, M′ = Ba, as M = Mg, M′ = Ba, Sr |
| CA 830387 | (LaₓLiEu)PO₄; X = Sr, Ba 0.01 < Eu/P < 0.24, |
| | 0.01 < Li/P < 0.24, 0.05 < Sr/P < 0.875, |
| | 0.05 < Ba/P < 0.7, (La + X + Li + Eu)/P = 1 |
| CA 561514 | Zn_{3-x-y}SnₓMn_{y}(PO₄)₂ 2.2 ≦ 3 − x − y ≦ 2.95, |
| | 0.02 ≦ x ≦ 0.1, 0.02 ≦ y ≦ 0.1 |
| CA 473094 | (Mg_{1-x-y-z}CeₓTh_{y}Mn_{z})₂P₂O₇ |
| | 0.001 ≦ x ≦ 0.2, 0.001 ≦ y ≦ 0.5, 0.01 ≦ z ≦ 0.8 |
| U.S. Pat. No. | M^{II}₂PO₄X: xEu²⁺; M^{II} = Ca, Sr, Ba, X = Cl, Br, |
| 4,931,652 | I; 0 < x ≦ 0.2 |

The invention provides novel phosphors with high luminescent intensity as compared to that of conventional phosphate phosphors. Accordingly, the present invention is a promising luminescent material in light emitting devices.

### BRIEF SUMMARY OF THE INVENTION

The invention provides a phosphate phosphors composed of (M₁₋ₓREₓ)₉M′(PO₄)₇ or M₉(M′_{1-y}RE′_{y})(PO₄)₇, wherein, M is Mg, Ca, Sr, Ba, Zn, or combinations thereof, M′ is Sc, Y, La, Gd, Al, Ga, In, or combinations thereof, RE is Pr, Nd, Eu, Gd, Tb, Ce, Dy, Yb, Er, Sc, Mn, Zn, or combinations thereof or combinations thereof, RE′ is Pr, Nd, Gd, Tb, Ce, Dy, Yb, Er, Bi, or combinations thereof, 0.001≦x≦0.8, and 0.001≦y<1.0.

In another embodiment of the invention, a method for fabricating the aforementioned phosphor is also provided, including the following steps: mixing a mixture which includes the following components: (1) M-containing compounds oxide; (2) M′-containing oxide; (3) (NH₄)₂HPO₄ or (NH₄)H₂PO₄; and (4) RE-containing or RE′-containing oxide; and sintering the mixture.

The invention also provides a light emitting device, including an excitation light source and the aforementioned phosphor.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a light emitting device according to an embodiment of the invention.

FIG. 2 is a cross section of a light emitting device according to another embodiment of the invention.

FIG. 3 shows the X-ray pattern of the phosphor as disclosed in Example 1.

FIG. 4 shows photoluminescence excitation and photoluminescence spectra of the phosphor as disclosed in Example 1 (excited by 351 nm light).

FIG. 5 shows the X-ray pattern of the phosphor as disclosed in Example 5.

FIG. 6 shows photoluminescence excitation and photoluminescence spectra of the phosphor as disclosed in Example 5 (excited by 351 nm light).

FIG. 7 shows the X-ray pattern of the phosphor as disclosed in Example 9.

FIG. 8 shows photoluminescence excitation and photoluminescence spectra of the phosphor as disclosed in Example 9 (excited by 395 nm light).

FIG. 9 shows the X-ray pattern of the phosphor as disclosed in Example 13.

FIG. 10 shows photoluminescence excitation and photoluminescence spectra of the phosphor as disclosed in Example 13 (excited by 395 nm light).

FIG. 11 shows the X-ray pattern of the phosphor as disclosed in Example 17.

FIG. 12 shows photoluminescence excitation and photoluminescence spectra of the phosphor as disclosed in Example 17 (excited by 397 nm light).

FIG. 13 shows the X-ray pattern of the phosphor as disclosed in Example 21.

FIG. 14 shows photoluminescence excitation and photoluminescence spectra of the phosphor as disclosed in Example 21 (excited by 340 nm light).

FIG. 15 shows the CIE coordinate of the phosphors as disclosed in Examples 1-21.

FIG. 16 shows excitation and photoluminescence spectra of the phosphors as disclosed in Example 22 represented by the structure of (Ca₁₋ₓEuₓ)₉Y(PO₄)₇ with different Ca/Eu ratio.

FIG. 17 shows the light emission intensity of the phosphors as disclosed in Example 22 represented by the structure of (Ca₁₋ₓEuₓ)₉Y(PO₄)₇ with different Ca/Eu ratio.

FIG. 18 shows excitation and photoluminescence spectra of the phosphors as disclosed in Example 23 represented by the structure of Ca₉(Y_{1-y}Pr_{y})(PO₄)₇ with different Y/Pr ratio (excited by 172 nm light).

FIG. 19 shows the photoluminescence spectrum of the phosphor as disclosed in Example 24 represented by the structure of Ca₉Gd(PO₄)₇ (excited by 172 nm light).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a phosphor having a formula:

(M₁₋ₓREₓ)₉M′(PO₄)₇ or M₉(M′_{1-y}RE′_{y})(PO₄)₇

wherein, M is Mg, Ca, Sr, Ba, Zn, or combinations thereof, M′ is Sc, Y, La, Gd, Al, Ga, In, or combinations thereof, RE is Pr, Nd, Eu, Gd, Tb, Ce, Dy, Yb, Er, Sc, Mn, Zn, or combinations thereof or combinations thereof, RE′ is Pr, Nd, Gd, Tb, Ce, Dy, Yb, Er, Bi, or combinations thereof, 0.001≦x≦0.8, and 0.001≦y≦1.0.

In an embodiment of the invention, M can be one or at least two of Mg, Ca, Sr, Ba, and Zn, M′ can be one or at least two of Sc, Y, La, Gd, Al, Ga, and In, RE can be one or at least two of Pr, Nd, Eu, Gd, Tb, Ce, Dy, Yb, Er, Sc, Mn, and Zn, and RE′ can be one or at least two of Pr, Nd, Gd, Tb, Ce, Dy, Yb, Er, and Bi.

The phosphors of the invention can be excited by a light with a wavelength of between 140-480 nm to emit a light with a major emission peak of between 230-603 nm.

In some embodiments of the invention, the phosphor of the invention can be (Ca_{0.9-x}Mg_{0.1}Euₓ)₉Y(PO₄)₇, (Ca_{0.9-x}Sr_{0.1}Euₓ)₉Y(PO₄)₇, (Ca_{0.9-x}Ba_{0.1}Euₓ)₉Y(PO₄)₇, (Ca_{0.9-x}Zn_{0.1}Euₓ)₉Y(PO₄)₇, (Ca₁₋ₓEuₓ)₉(Y_{0.5}Sc_{0.5})(PO₄)₇, (Ca₁₋ₓEuₓ)₉Y(PO₄)₇, (Ca₁₋ₓEuₓ)₉La(PO₄)₇, (Ca₁₋ₓEuₓ)₉Gd(PO₄)₇, (Ca₁₋ₓEuₓ)₉Al(PO₄)₇, Ca₈EuAl(PO₄)₇, Ca₆Eu₃Al(PO₄)₇, Ca₄Eu₅Al(PO₄)₇, (Ca₁₋ₓEuₓ)₉Ga(PO₄)₇, Ca₈EuGa(PO₄)₇, Ca₆Eu₃Ga(PO₄)₇, Ca₄Eu₅Ga(PO₄)₇, (Ca₁₋ₓEuₓ)₉In(PO₄)₇, Ca₈EuIn(PO₄)₇, Ca₆Eu₃In(PO₄)₇, Ca₄Eu₅In(PO₄)₇, (Sr₁₋ₓEuₓ)₉In(PO₄)₇, Ca₉Gd(PO₄)₇, or Ca₉(Y_{1-y}Pr_{y}) (PO₄)₇ wherein 0.001≦x≦0.8, and 0.001≦y<1.0.

When the phosphor of the invention is (Ca₁₋ₓEuₓ)₉Y(PO₄)₇ and x=0.01, the phosphor can be excited by a light with a wavelength of between 250-450 nm to emit a blue light having a major emission peak of 488 nm and a CIE coordinate of (0.208, 0.321). The phosphor can serve as a luminescence conversion material for a UV-LED (having a wavelength of 250-450 nm).

When the phosphor of the invention is Ca₉₋ₓEuₓAl(PO₄)₇, Ca₉₋ₓEuₓGa(PO₄)₇, or Ca₉₋ₓEuₓIn(PO₄)₇ and x=5, the phosphor can be excited by a light with a wavelength of between 300-500 nm to emit a red light having a major emission peak of between 594-603 nm and a CIE coordinate of (0.536, 0.447). The phosphor can serve as a luminescence conversion material for a Blue-LED (having a emission wavelength of 480-750 nm).

When the phosphor of the invention is Ca₉(Y_{0.5}Pr_{0.5})(PO₄)₇, the phosphor can be excited by a light with a wavelength of between 140-230 nm to emit a UV light having a major emission peak of between 230-320 nm. The phosphor can be further combined with an excimer lamp and be applied in medicine or water treatment.

In embodiments of the invention, a method for fabricating the aforementioned phosphor is provided, wherein a mixture including the following components: (1) M-containing oxide; (2) M′-containing oxide; (3) (NH₄)₂HPO₄ or (NH₄)H₂PO₄; and (4) RE-containing or RE′-containing oxide are mixed and sintered. The step of sintering the mixture can have a sintering temperature of between 800-1300° C., and the mixture can be sintered at the sintering temperature for 0.5-32 hr.

According to embodiments of the invention the (1) M-containing oxide can include oxide of Mg, Ca, Sr, Ba, or Zn, carbonate of Mg, Ca, Sr, Ba, or Zn, or nitrate of Mg, Ca, Sr, Ba, or Zn. The (2) M′-containing oxide can include oxide of Sc, Y, La, Gd, Al, Ga, or In, or nitrate of Sc, Y, La, Gd, Al, Ga, or In. The RE-containing oxide can include oxide of Pr, Nd, Eu, Gd, Tb, Ce, Dy, Yb, Er, Sc, Mn, or Zn, or nitrate of Pr, Nd, Eu, Gd, Tb, Ce, Dy, Yb, Er, Sc, Mn, or Zn. The RE′-containing oxide can include oxide of Pr, Nd, Gd, Tb, Ce, Dy, Yb, Er, Bi, or nitrate of Pr, Nd, Gd, Tb, Ce, Dy, Yb, Er, Bi.

According to embodiments of the invention, a light emitting device is also provided, including an excitation light source and the aforementioned phosphor. The excitation light source (configured to emit a radiation having a wavelength ranging from about 140 to 420 nm) can include a blue or ultraviolet light emitting diode (LED), a laser diode (LD), a vacuum ultraviolet (VUV), or Hg vapor arc. The light emitting device can be an external electrode fluorescent lamp (EEFL), a liquid crystal display (LCD), an organic light emitting diode (OLED), a plasma display panel (PDP), a light emitting diode (LED) device, a excimer lamp or a cold cathode fluorescent lamp (CCFL).

The light emitting device can be a white light emitting device. The white light emitting device employing the aforementioned phosphors of the invention may further employ UV or blue light excitable phosphors, such blue, yellow, red, or green phosphors. The yellow phosphor includes Y₃Al₅O₁₂:Ce³⁺ (YAG), Tb₃Al₅O₁₂:Ce³⁺ (TAG), (Ca,Mg,Y)Si_{w}AlₓO_{y}N_{z}:Eu²⁺ or (Mg,Ca,Sr,Ba)₂SiO₄:Eu²⁺. The red phosphor includes (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺, (Ca,Sr,Ba)₂Si₅N₈:Eu²⁺, (Ca,Sr)AlSiN₃:Eu²⁺, Sr₃SiO₅:Eu²⁺, Ba₃MgSi₂O₈:Eu²⁺,Mn²⁺, Ca₂Si₅N₈:Eu²⁺ or ZnCdS:AgCl. The blue phosphor includes BaMgAl₁₀O₁₇Eu²⁺, (Sr,Ca,Ba,Mg)₅(PO₄)₃Cl:Eu²⁺, Ca₂PO₄Cl:Eu²⁺, Sr₂Al₆O₁₁:Eu²⁺, or CaAl₂O₄:Eu²⁺. The green phosphor includes BaMgAl₁₀O₁₇:Eu²⁺,Mn²⁺ (BAM-Mn), SrSi₂N₂O₂:Eu²⁺, CaSc₂O₄:Ce³⁺, Ca₃Sc₂Si₃O₁₂:Ce³⁺, (Ca,Sr,Ba)₄Al₁₄O₂₅:Eu₂₊, Ca₈Mg(SiO₄)₄Cl₂:Eu₂₊, Mn²⁺, or (Ba,Sr)₂SiO₄:Eu²⁺.

The light emitting device can serve as a pilot device (such as traffic sign, and pilot lamb of an instrument), back light source (such as a back light of an instrument and a display), light fitting (such as bias light, traffic sign, or signboard), or germicidal lamp.

According to an embodiment of the invention, referring to FIG. 1, the light emitting device 10 has a lamp tube 12, a phosphor disposed on the inside walls of the lamp tube 12, an excitation light source 16, and electrodes 18 disposed on each of two ends of the lamp tube 12. Further, the lamp tube 12 of the light emitting device 10 can further include Hg and an inert gas. The phosphor 14 can include the phosphor of the invention. Moreover, the phosphor 14 can further include a yellow phosphor, or a combination of a red phosphor and a green phosphor for generating white-light radiation. The light emitting device 10 can serve as a back light source of a liquid crystal display.

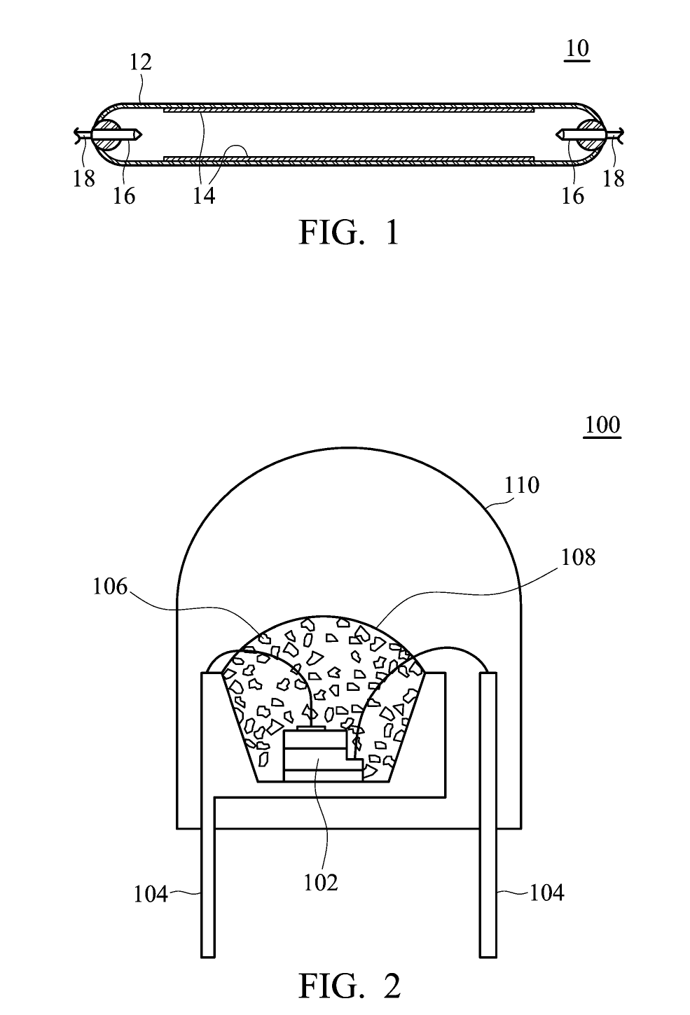

According to another embodiment of the invention, referring to FIG. 2, the light emitting device 100 employs a light emitting diode or laser diode 102 as an excitation light source, and the light emitting diode or laser diode 102 is disposed on a lead frame 104. A transparent resin 108 mixed with a phosphor 106 is coated to cover the light emitting diode or laser diode 102. A sealing material 110 is used to encapsulate the light emitting diode or laser diode 102, the lead frame 104, and the transparent resin 108.

The following examples are intended to illustrate the invention more fully without limiting their scope, since numerous modifications and variations will be apparent to those skilled in this art.

### Example 1

0.7220 g of CaCO₃, 0.0326 g of MgO, 0.0142 g of Eu₂O₃, 0.1016 g of Y₂O₃ and 0.8325 g of (NH₄)₂HPO₄ were weighted, evenly mixed and grinded, and charged in a alumina crucible. The alumina crucible was then heated in a high temperature furnace. After sintering at 1000° C.-1200° C. for 8 hours under air, and washing, filtering, and heat drying, a pure phase of the phosphor (Ca_{0.89}Mg_{0.1}Eu_{0.01})₉Y(PO₄)₇ was prepared.

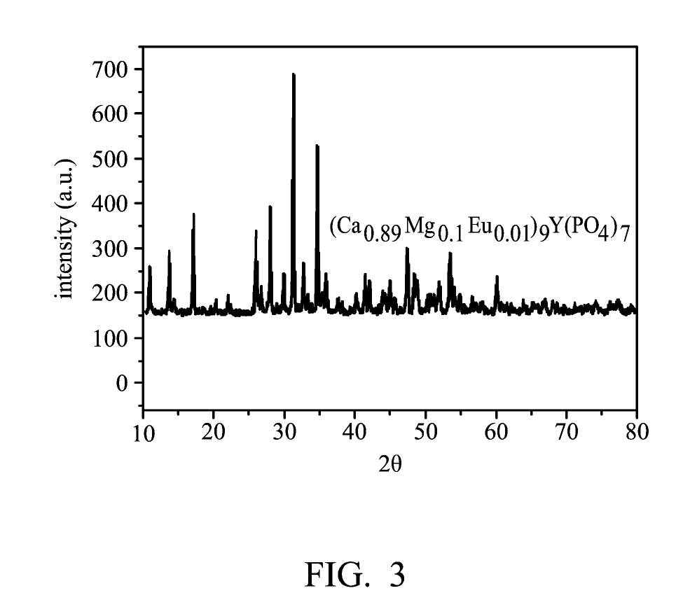

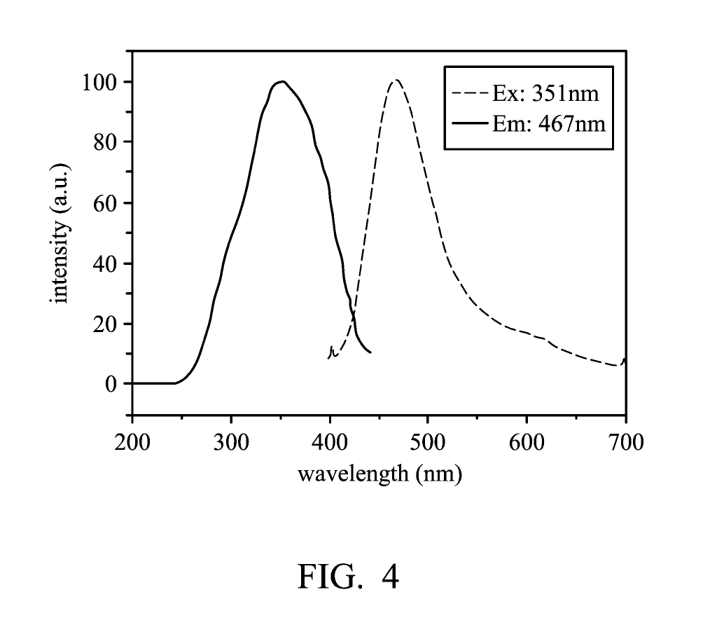

The excitation wavelength, emission wavelength, and CIE coordinate of the described product were measured. The results are shown in Table 2. Further, the X-ray diffraction pattern of the described product is shown in FIG. 3 and the photoluminescence excitation and photoluminescence spectra of the described product are shown in FIG. 4 (excited by 351 nm light). The phosphor had wide excitation band, and the major peak of the emission band was 467 nm.

### Example 2

0.6867 g of CaCO₃, 0.1138 g of SrCO₃, 0.0135 g of Eu₂O₃, 0.0967 g of Y₂O₃, and 0.7919 g of (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor (Ca_{0.89}Sr_{0.1}Eu_{0.01})₉Y(PO₄)₇ was prepared.

The excitation wavelength, emission wavelength, and CIE coordinate of the described product were measured. The results are shown in Table 2.

### Example 3

0.6614 g of CaCO₃, 0.1465 g of BaCO₃, 0.0130 g of Eu₂O₃, 0.0931 g of Y₂O₃, and 0.7626 g of (NH₄)₂HPO₄ were weighted, evenly mixed and grinded, and charged in a alumina crucible. The alumina crucible was then heated in a high temperature furnace.

After sintering at 1000° C.-1300° C. for 8 hours under air, and washing, filtering, and heat drying, a pure phase of the phosphor (Ca_{0.89}Ba_{0.1}Eu_{0.01})₉Y(PO₄)₇ was prepared.

The excitation wavelength, emission wavelength, and CIE coordinate of the described product were measured. The results are shown in Table 2.

### Example 4

0.6987 g of CaCO₃, 0.0638 g of ZnO, 0.0138 g of Eu₂O₃, 0.0984 g of Y₂O₃, and 0.8057 g of (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor (Ca_{0.89}Zn_{0.1}Eu_{0.01})₉Y(PO₄)₇ was prepared.

The excitation wavelength, emission wavelength, and CIE coordinate of the described product were measured. The results are shown in Table 2.

### Example 5

0.8087 g of CaCO₃, 0.0143 g of Eu₂O₃, 0.0512 g of Y₂O₃, 0.0312 g of Sc₂O₃, and 0.8384 g of (NH₄)₂HPO₄ were weighted, evenly mixed and grinded, and charged in a alumina crucible. The alumina crucible was then heated in a high temperature furnace. After sintering at 1000° C.-1200° C. for 8 hours under air, and washing, filtering, and heat drying, a pure phase of the phosphor (Ca_{0.99}Eu_{0.01})₉(Y_{0.5}Sc_{0.5})(PO₄)₇ was prepared.

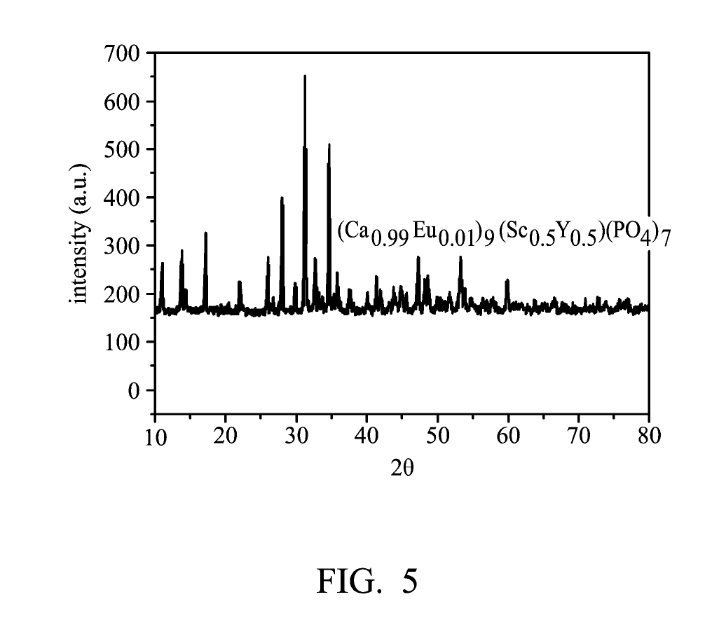

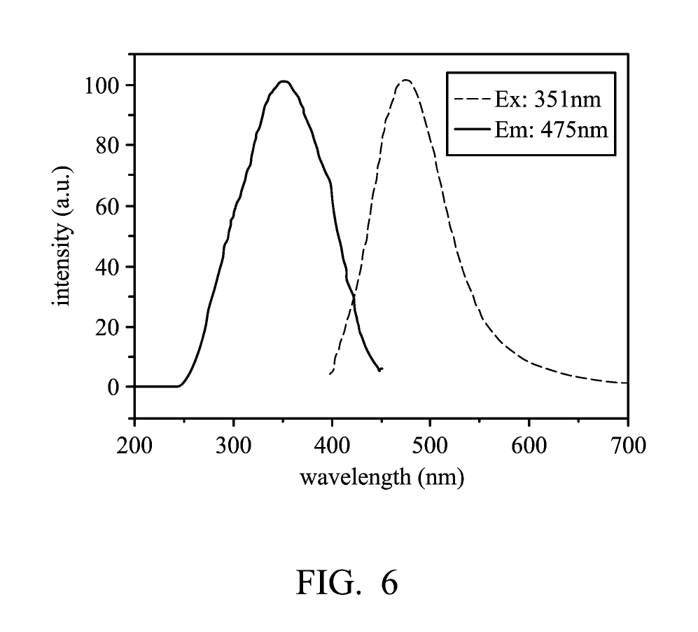

The excitation wavelength, emission wavelength, and CIE coordinate of the described product were measured. The results are shown in Table 2. Further, the X-ray diffraction spectrum of the described product is shown in FIG. 5 and the photoluminescence excitation and photoluminescence spectra of the described product are shown in FIG. 6 (excited by 351 nm light). The phosphor had wide excitation band, and the major peak of the emission band was 475 nm.

### Example 6

0.7929 g of CaCO₃, 0.0140 g of Eu₂O₃, 0.1003 g of Y₂O₃, and 0.8220 g of (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor (Ca_{0.99}Eu_{0.01})₉Y(PO₄)₇ was prepared.

The excitation wavelength, emission wavelength, and CIE coordinate of the described product were measured. The results are shown in Table 2.

### Example 7

0.7592 g of CaCO₃, 0.0134 g of Eu₂O₃, 0.1386 g of La₂O₃, and 0.7870 g of (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor (Ca_{0.99}Eu_{0.01})₉La(PO₄)₇ was prepared.

The excitation wavelength, emission wavelength, and CIE coordinate of the described product were measured. The results are shown in Table 2.

### Example 8

0.7475 g of CaCO₃, 0.0132 g of Eu₂O₃, 0.1519 g of Gd₂O₃, and 0.7749 g of (NH₄)₂HPO₄ were weighted, evenly mixed and grinded, and charged in a alumina crucible.

The alumina crucible was then heated in a high temperature furnace. After sintering at 1000° C.-1300° C. for 8 hours under air, and washing, filtering, and heat drying, a pure phase of the phosphor (Ca_{0.99}Eu_{0.01})₉Gd(PO₄)₇ was prepared.

The excitation wavelength, emission wavelength, and CIE coordinate of the described product were measured. The results are shown in Table 2.

### Example 9

0.7029 g of CaCO₃, 0.1373 g of Eu₂O₃, 0.0442 g of Al₂O₃, and 0.8015 g of (NH₄)₂HPO₄ were weighted, evenly mixed and grinded, and charged in a alumina crucible. The alumina crucible was then heated in a high temperature furnace. After sintering at 1000° C.-1400° C. for 8 hours under air, and washing, filtering, and heat drying, a pure phase of the phosphor (Ca_{0.9}Eu_{0.1})₉Y(PO₄)₇ was prepared.

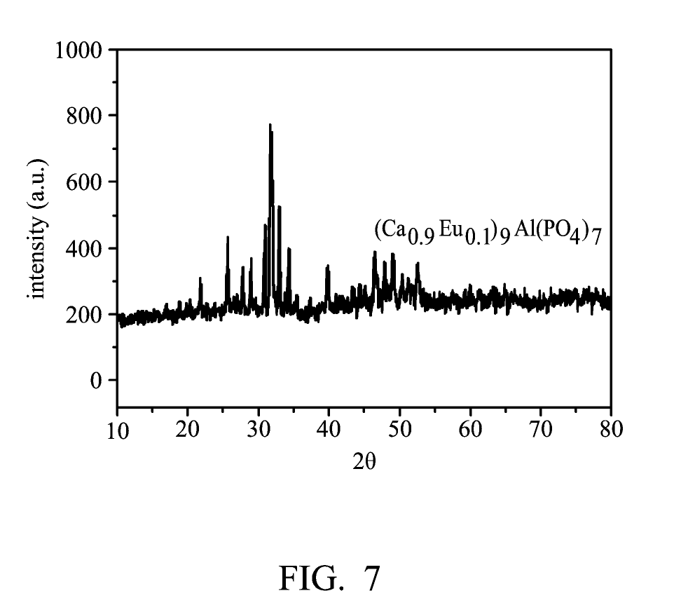

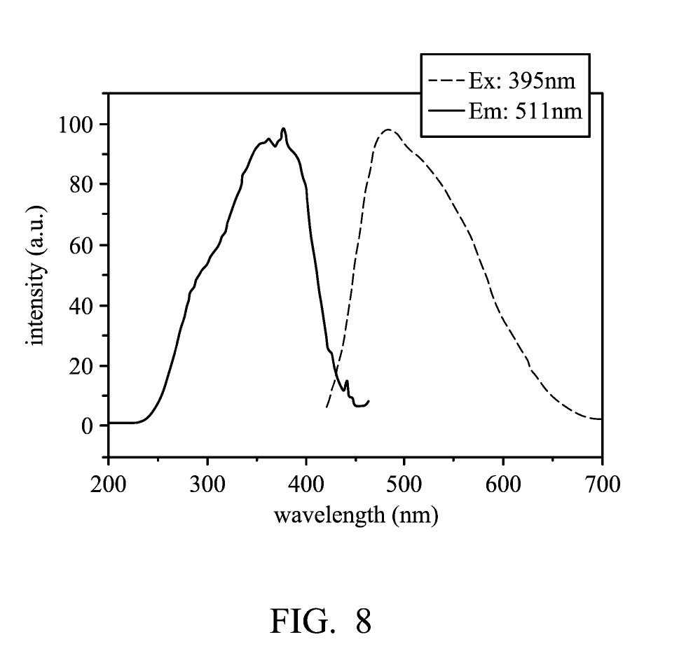

The excitation wavelength, emission wavelength, and CIE coordinate of the described product were measured. The results are shown in Table 2. Further, the X-ray diffraction spectrum of the described product is shown in FIG. 7 and the photoluminescence excitation and photoluminescence spectra of the described product are shown in FIG. 8 (excited by 395 nm light).

### Example 10

0.8676 g of CaCO₃, 0.1511 g of Eu₂O₃, 0.0437 g of Al₂O₃, and 0.7938 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₈EuAl(PO₄)₇ was prepared.

The excitation wavelength, emission wavelength, and CIE coordinate of the described product were measured. The results are shown in Table 2.

### Example 11

0.4325 g of CaCO₃, 0.3802 g of Eu₂O₃, 0.0367 g of Al₂O₃, and 0.6659 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₆Eu₃Al(PO₄)₇ was prepared.

The excitation wavelength, emission wavelength, and CIE coordinate of the described product were measured. The results are shown in Table 2.

### Example 12

0.2483 g of CaCO₃, 0.5457 g of Eu₂O₃, 0.0316 g of Al₂O₃, and 0.5735 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₄Eu₅Al(PO₄)₇ was prepared.

The excitation wavelength, emission wavelength, and CIE coordinate of the described product were measured. The results are shown in Table 2.

### Example 13

0.6778 g of CaCO₃, 0.1324 g of Eu₂O₃, 0.0783 g of Ga₂O₃, and 0.7729 g of (NH₄)₂HPO₄ were weighted, evenly mixed and grinded, and charged in a alumina crucible. The alumina crucible was then heated in a high temperature furnace. After sintering at 1000° C.-1400° C. for 8 hours under air, and washing, filtering, and heat drying, a pure phase of the phosphor (Ca_{0.9}Eu_{0.1})₉Y(PO₄)₇ was prepared.

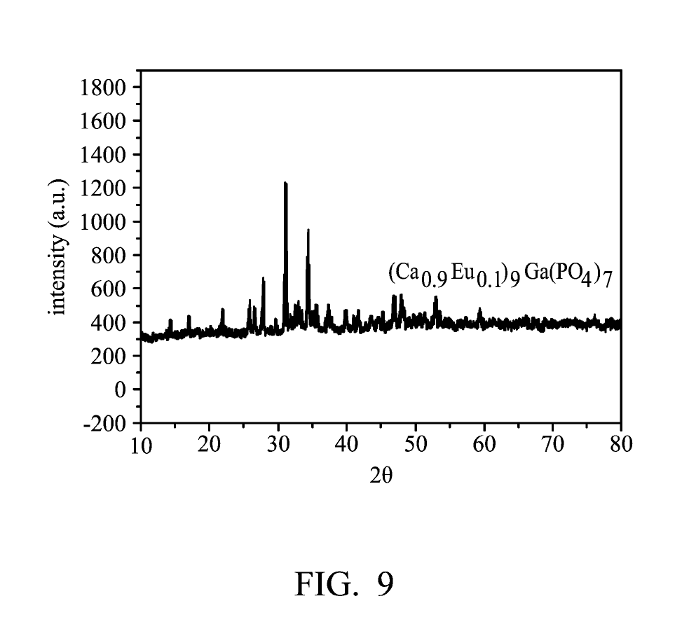

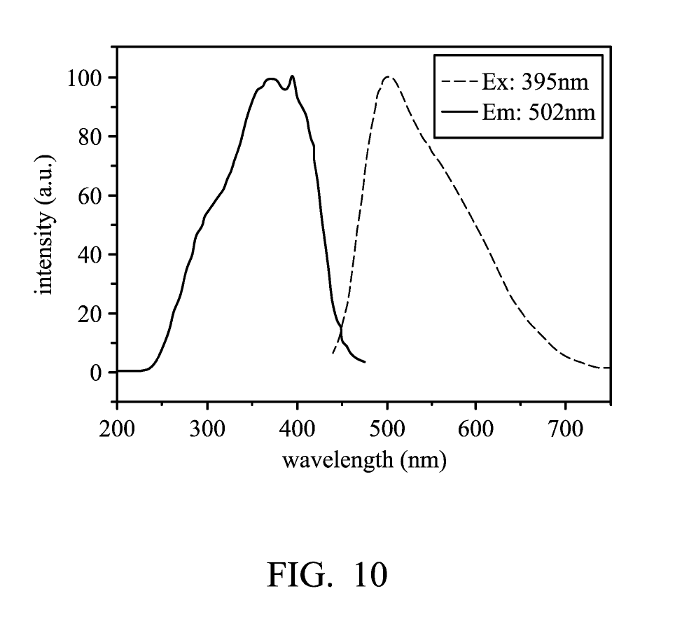

The excitation wavelength, emission wavelength, and CIE coordinate of the described product were measured. The results are shown in Table 2. Further, the X-ray diffraction spectrum of the described product is shown in FIG. 9 and the photoluminescence excitation and photoluminescence spectra of the described product are shown in FIG. 10 (excited by 395 nm light).

### Example 14

0.6632 g of CaCO₃, 0.1457 g of Eu₂O₃, 0.0776 g of Ga₂O₃, and 0.7657 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₈EuGa(PO₄)₇ was prepared.

The excitation wavelength, emission wavelength, and CIE coordinate of the described product were measured. The results are shown in Table 2.

### Example 15

0.4196 g of CaCO₃, 0.3688 g of Eu₂O₃, 0.0654 g of Ga₂O₃, and 0.6460 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₆Eu₃Ga(PO₄)₇ was prepared.

The excitation wavelength, emission wavelength, and CIE coordinate of the described product were measured. The results are shown in Table 2.

### Example 16

0.2419 g of CaCO₃, 0.5316 g of Eu₂O₃, 0.0566 g of Ga₂O₃, and 0.5587 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₄Eu₅Ga(PO₄)₇ was prepared.

The excitation wavelength, emission wavelength, and CIE coordinate of the described product were measured. The results are shown in Table 2.

### Example 17

0.6532 g of CaCO₃, 0.1275 g of Eu₂O₃, 0.1118 g of In₂O₃, and 0.7448 g of (NH₄)₂HPO₄ were weighted, evenly mixed and grinded, and charged in a alumina crucible. The alumina crucible was then heated in a high temperature furnace. After sintering at 1000° C.-1400° C. for 8 hours under air, and washing, filtering, and heat drying, a pure phase of the phosphor (Ca_{0.9}Eu_{0.1})₉In(PO₄)₇ was prepared.

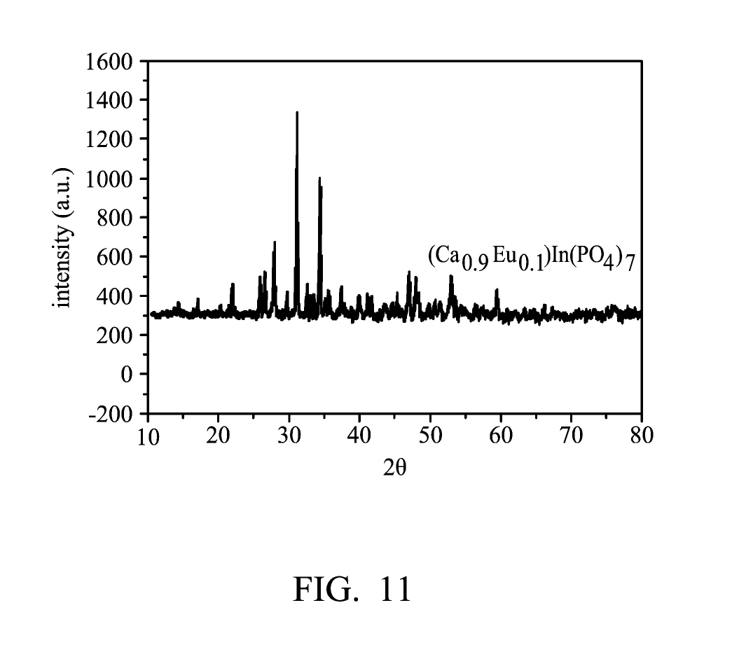

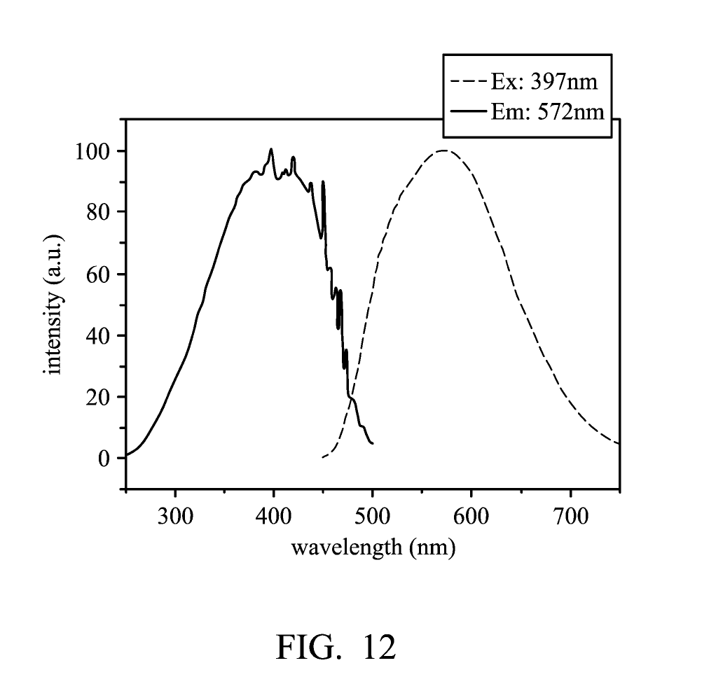

The excitation wavelength, emission wavelength, and CIE coordinate of the described product were measured. The results are shown in Table 2. Further, the X-ray diffraction spectrum of the described product is shown in FIG. 11 and the photoluminescence excitation and photoluminescence spectra of the described product are shown in FIG. 12. Further, Ca₉In(PO₄)₇ did not have photoluminescence spectra during excitation.

### Example 18

0.6393 g of CaCO₃, 0.1405 g of Eu₂O₃, 0.1108 g of In₂O₃, and 0.7382 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₈EuIn(PO₄)₇ was prepared.

The excitation wavelength, emission wavelength, and CIE coordinate of the described product were measured. The results are shown in Table 2.

### Example 19

0.4068 g of CaCO₃, 0.3576 g of Eu₂O₃, 0.0940 g of In₂O₃, and 0.6263 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₆Eu₃In(PO₄)₇ was prepared.

The excitation wavelength, emission wavelength, and CIE coordinate of the described product were measured. The results are shown in Table 2.

### Example 20

0.2355 g of CaCO₃, 0.5175 g of Eu₂O₃, 0.0816 g of In₂O₃, and 0.5438 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₄Eu₅In(PO₄)₇ was prepared.

The excitation wavelength, emission wavelength, and CIE coordinate of the described product were measured. The results are shown in Table 2.

### Example 21

0.8356 g of SrCO₃, 0.0100 g of Eu₂O₃, 0.0881 g of In₂O₃, and 0.5873 g of (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor (Sr_{0.99}Eu_{0.01})₉In(PO₄)₇ was prepared.

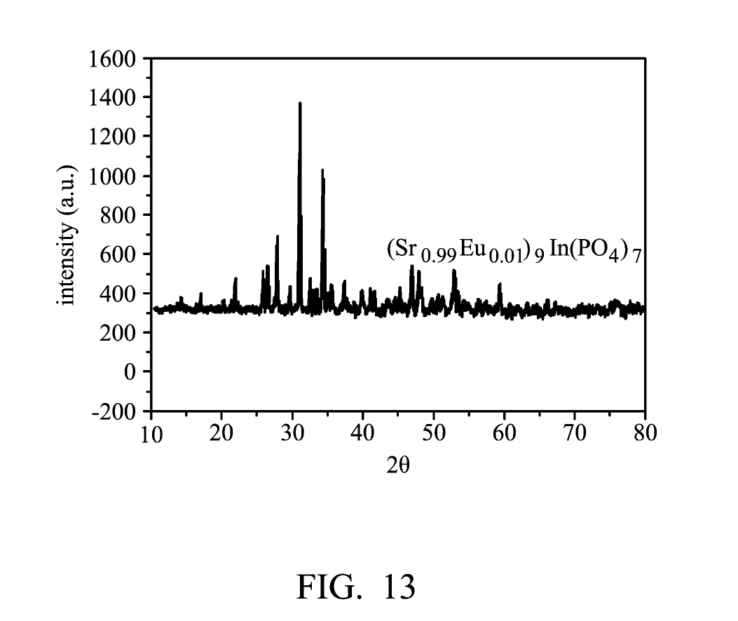

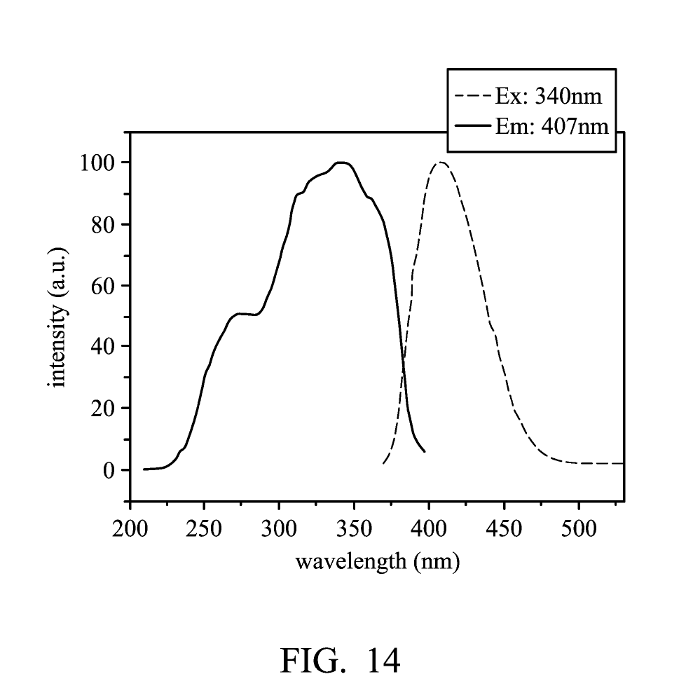

The excitation wavelength, emission wavelength, and CIE coordinate of the described product were measured. The results are shown in Table 2. Further, the X-ray diffraction spectrum of the described product is shown in FIG. 13 and the photoluminescence excitation and photoluminescence spectra of the described product are shown in FIG. 14 (excited by 340 nm light).

TABLE 2

| | | Exciting | Emission | |
|---|---|---|---|---|
| | | wavelength | wavelength | |
| Example | phosphor | (nm) | (nm) | CIE |
| 1 | (Ca_{0.89}Mg_{0.1}Eu_{0.01})₉Y(PO₄)₇ | 351 nm | 467 nm | (0.237, 0.219) |
| 2 | (Ca_{0.89}Sr_{0.1}Eu_{0.01})₉Y(PO₄)₇ | 365 nm | 492 nm | (0.226, 0.358) |
| 3 | (Ca_{0.89}Ba_{0.1}Eu_{0.01})₉Y(PO₄)₇ | 371 nm | 495 nm | (0.243, 0.379) |
| 4 | (Ca_{0.89}Zn_{0.1}Eu_{0.01})₉Y(PO₄)₇ | 355 nm | 485 nm | (0.202, 0.287) |
| 5 | (Ca_{0.99}Eu_{0.01})₉(Y_{0.5}Sc_{0.5})(PO₄)₇ | 351 nm | 475 nm | (0.266, 0.329) |
| 6 | (Ca_{0.99}Eu_{0.01})₉Y(PO₄)₇ | 365 nm | 488 nm | (0.208, 0.321) |
| 7 | (Ca_{0.99}Eu_{0.01})₉La(PO₄)₇ | 352 nm | 505 nm | (0.272, 0.399) |
| 8 | (Ca_{0.99}Eu_{0.01})₉Gd(PO₄)₇ | 350 nm | 490 nm | (0.217, 0.301) |
| 9 | (Ca_{0.9}Eu_{0.1})₉Al(PO₄)₇ | 395 nm | 511 nm | (0.368, 0.443) |
| 10 | Ca₈EuAl(PO₄)₇ | 397 nm | 500 nm | (0.336, 0.464) |
| 11 | Ca₆Eu₃Al(PO₄)₇ | 397 nm | 566 nm | (0.472, 0.475) |
| 12 | Ca₄Eu₅Al(PO₄)₇ | 450 nm | 594 nm | (0.510, 0.471) |
| 13 | (Ca_{0.9}Eu_{0.1})₉Ga(PO₄)₇ | 395 nm | 502 nm | (0.334, 0.384) |
| 14 | Ca₈EuGa(PO₄)₇ | 397 nm | 500 nm | (0.346, 0.465) |
| 15 | Ca₆Eu₃Ga(PO₄)₇ | 397 nm | 572 nm | (0.481, 0.473) |
| 16 | Ca₄Eu₅Ga(PO₄)₇ | 450 nm | 603 nm | (0.534, 0.449) |
| 17 | (Ca_{0.9}Eu_{0.1})₉In(PO₄)₇ | 396 nm | 500 nm | (0.347, 0.441) |
| 18 | Ca₈EuIn(PO₄)₇ | 397 nm | 501 nm | (0.345, 0.466) |
| 19 | Ca₆Eu₃In(PO₄)₇ | 397 nm | 572 nm | (0.482, 0.473) |
| 20 | Ca₄Eu₅In(PO₄)₇ | 450 nm | 603 nm | (0.536, 0.447) |
| 21 | (Sr_{0.99}Eu_{0.01})₉In(PO₄)₇ | 340 nm | 407 nm | (0.185, 0.067) |

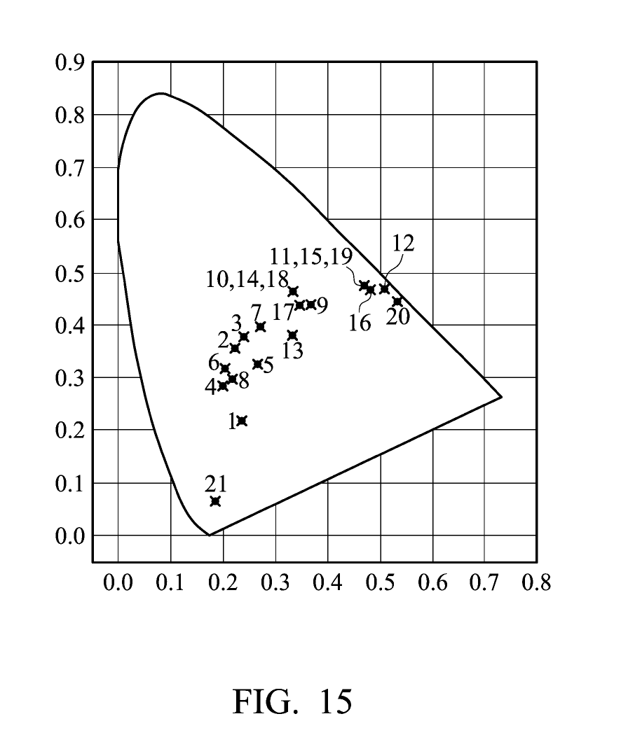

Further, the CIE coordinate of the phosphors as disclosed in Examples 1-21 are shown in FIG. 15.

### Example 22

For Example 22, a similar process to that according to Example 6 was performed except that the Ca/Eu ratio was respectively replaced with 999:1, 997:3, 995:5, 993:7, 99:1, 97:3, 95:5, and 9:1 (i.e. x=0.001, 0.003, 0.005, 0.007, 0.01, 0.03, and 0.1).

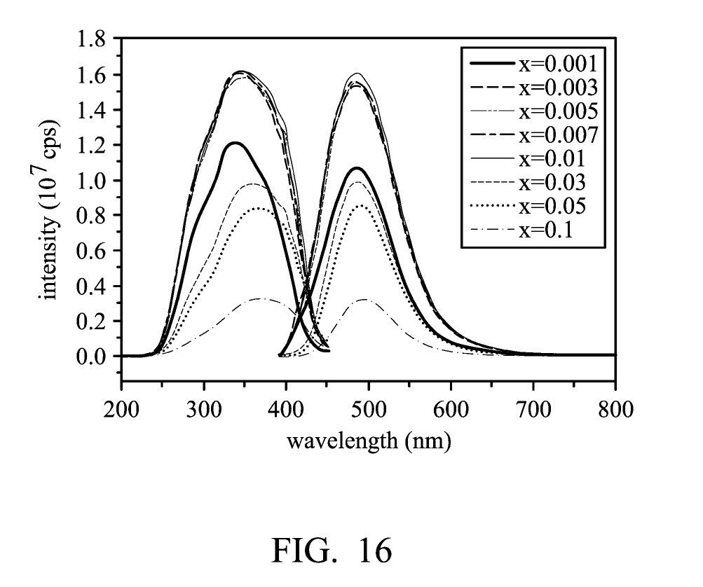

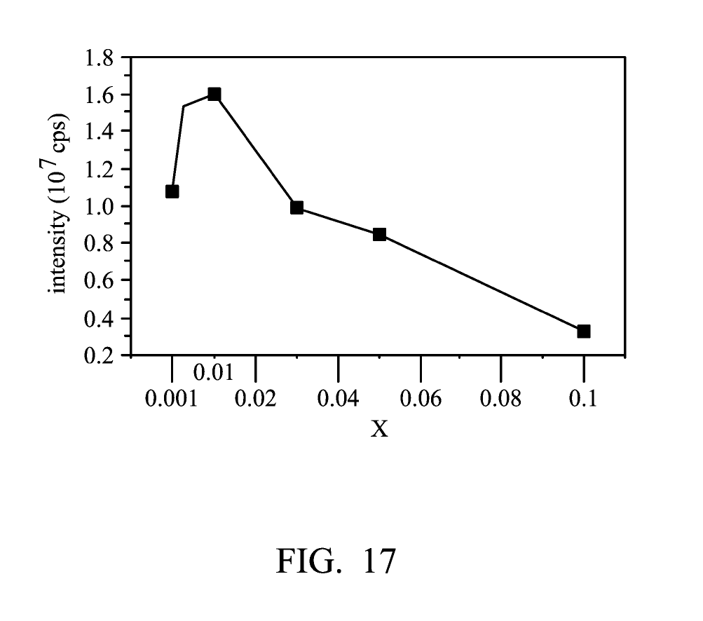

The photoluminescence excitation and photoluminescence spectra of the obtained products are shown in FIG. 16. Further, FIG. 17 shows the light emission intensity of the phosphors as disclosed in Example 22 represented by the structure of (Ca₁₋ₓEuₓ)₉Y(PO₄)₇ with different Ca/Eu ratios. Accordingly, an increase of Eu concentration had little effect on light emission intensity, but the phosphors with relatively high or low Eu concentrations exhibited poor light emission intensity. When the Ca/Eu ratio was between 997:3 to 99:1, (Ca₁₋ₓEuₓ)₉Y(PO₄)₇ (x is between 0.003-0.01) exhibited good light emission intensity.

### Example 23

CaCO₃, Y₂O₃, Pr₂O₃, and (NH₄)₂HPO₄ were weighted, evenly mixed and grinded, and charged in a alumina crucible. The alumina crucible was then heated in a high temperature furnace. After sintering at 1000° C.-1300° C. for 8 hours under air, and washing, filtering, and heat drying, a pure phase of the phosphor Ca₉(Y_{1-y}Pr_{y})(PO₄)₇ was prepared, wherein y was respectively 0.1, 0.3, or 0.5.

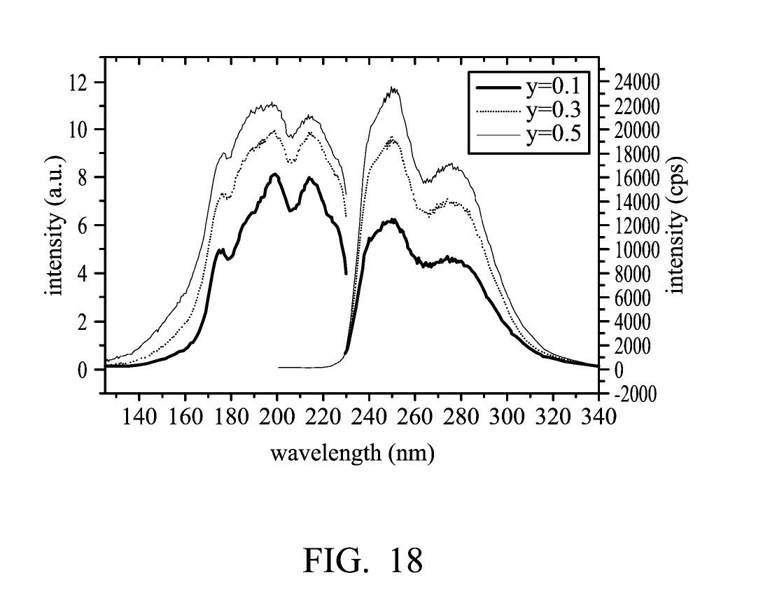

The photoluminescence excitation and photoluminescence spectra of the described product are shown in FIG. 18 (excited by 172 nm light). Accordingly, the phosphor was excited by a light with a wavelength of between 140-230 nm to emit a light with a major emission peak of between 230-320 nm. Therefore, the described phosphors can be further combined with an excimer lamp and be applied in medicine or water treatment.

### Example 24

0.9007 g of CaCO₃, 0.1810 g of Ga₂O₃, and 0.9240 g of (NH₄)₂HPO₄ were weighted, evenly mixed and grinded, and charged in a alumina crucible. The alumina crucible was then heated in a high temperature furnace. After sintering at 1000° C.-1500° C. for 8 hours under air, and washing, filtering, and heat drying, a pure phase of the phosphor Ca₉Gd(PO₄)₇ was prepared.

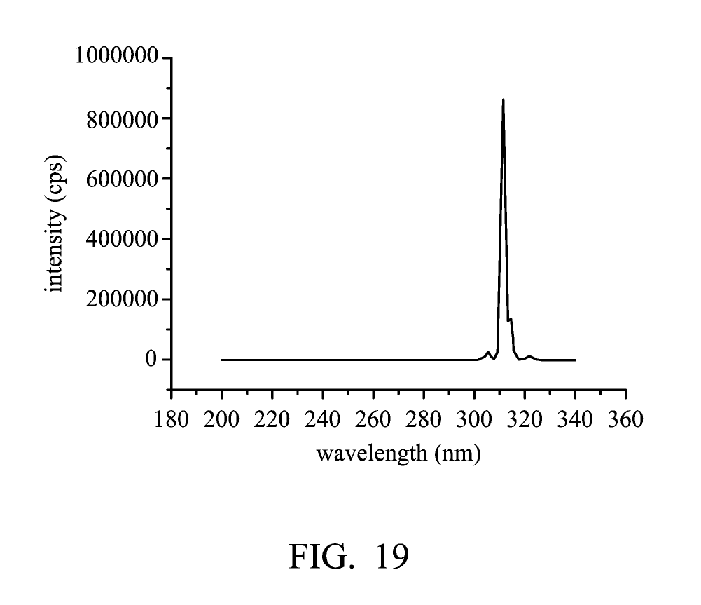

The photoluminescence excitation and photoluminescence spectra of the described product are shown in FIG. 19 (excited by 172 nm light).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A phosphor, having a formula:
(M₁₋ₓREₓ)₉M′(PO₄)₇ or M₉(M′_{1-y}RE′_{y})(PO₄)₇
wherein, M is Mg, Ca, Sr, Ba, Zn, or combinations thereof, M′ is Sc, Y, La, Gd, Al, Ga, In, or combinations thereof, RE is Pr, Nd, Eu, Gd, Tb, Ce, Dy, Yb, Er, Sc, Mn, Zn, or combinations thereof, RE′ is Pr, Nd, Gd, Tb, Ce, Dy, Yb, Er, Bi, or combinations thereof, 0.001≦x≦0.8, and 0.001≦y≦1.0.

2. The phosphor as claimed in claim 1, wherein the phosphor is excited by a light with a wavelength of between 140-480 nm to emit a light with a major emission peak of between 230-603 nm.

3. The phosphor as claimed in claim 1, wherein the phosphor comprises (Ca_{0.9-x}Mg_{0.1}Euₓ)₉Y(PO₄)₇, (Ca_{0.9-x}Sr_{0.1}Euₓ)₉Y(PO₄)₇, (Ca_{0.9-x}Ba_{0.1}Euₓ)₉Y(PO₄)₇, (Ca_{0.9-x}Zn_{0.1}Euₓ)₉Y(PO₄)₇, (Ca₁₋ₓEuₓ)₉(Y_{0.5}Sc_{0.5})(PO₄)₇, (Ca₁₋ₓEuₓ)₉Y(PO₄)₇, (Ca₁₋ₓEuₓ)₉La(PO₄)₇, (Ca₁₋ₓEuₓ)₉Gd(PO₄)₇, (Ca₁₋ₓEuₓ)₉Al(PO₄)₇, Ca₈EuAl(PO₄)₇, Ca₆Eu₃Al(PO₄)₇, Ca₄Eu₅Al(PO₄)₇, (Ca₁₋ₓEuₓ)₉Ga(PO₄)₇, Ca₈EuGa(PO₄)₇, Ca₆Eu₃Ga(PO₄)₇, Ca₄Eu₅Ga(PO₄)₇, (Ca₁₋ₓEuₓ)₉In(PO₄)₇, Ca₈EuIn(PO₄)₇, Ca₆Eu₃In(PO₄)₇, Ca₄Eu₅In(PO₄)₇, (Sr₁₋ₓEuₓ)₉In(PO₄)₇, Ca₉Gd(PO₄)₇, or Ca₉(Y_{1-y}Pr_{y})(PO₄)₇, wherein 0.001≦x≦0.8, and 0.001≦y<1.0.

4. The phosphor as claimed in claim 1, wherein the phosphor comprises (Ca_{0.9}Eu_{0.1})₉Y(PO₄)₇, and the phosphor emits a light with a major emission peak of between 485-490 nm.

5. The phosphor as claimed in claim 4, wherein the blue light has a CIE coordinate of (0.208, 0.321).

6. The phosphor as claimed in claim 1, wherein the phosphor comprises Ca₄Eu₅Al(PO₄)₇, Ca₄Eu₅Ga(PO₄)₇, or Ca₄Eu₅In(PO₄)₇, and the phosphor emits a light with a major emission peak of between 594-603 nm.

7. The phosphor as claimed in claim 1, wherein the phosphor comprises Ca₉(Y_{0.5}Pr_{0.5})(PO₄)₇, and the phosphor emits a light with a major emission peak of between 230-320 nm.

8. A method for fabricating a phosphor, having a formula:
(M₁₋ₓREₓ)₉M′(PO₄)₇ or M₉(M′_{1-y}RE′_{y})(PO₄)₇
wherein, M is Mg, Ca, Sr, Ba, Zn, or combinations thereof, M′ is Sc, Y, La, Gd, Al, Ga, In, or combinations thereof, RE is Pr, Nd, Eu, Gd, Tb, Ce, Dy, Yb, Er, Sc, Mn, Zn, or combinations thereof or combinations thereof, RE′ is Pr, Nd, Gd, Tb, Ce, Dy, Yb, Er, Bi, or combinations thereof, 0.001≦x≦0.8, and 0.001≦y≦1.0,
comprising:
mixing a mixture which comprises the following components: (1) M-containing oxide; (2) M′-containing oxide; (3) (NH₄)₂HPO₄ or (NH₄)H₂PO₄; and (4) RE-containing or RE′-containing oxide; and
sintering the mixture.

9. The method as claimed in claim 8, wherein the step of sintering the mixture has a sintering temperature of between 800-1300° C.

10. The method as claimed in claim 9, wherein the mixture is sintered at the sintering temperature for 0.5-32 hr.

11. The method as claimed in claim 8, wherein the (1) M-containing oxide comprises of Mg, Ca, Sr, Ba, or Zn, carbonate of Mg, Ca, Sr, Ba, or Zn, or nitrate of Mg, Ca, Sr, Ba, or Zn.

12. The method as claimed in claim 8, wherein the (2) M′-containing compound comprises oxide of Sc, Y, La, Gd, Al, Ga, or In, or nitrate of Sc, Y, La, Gd, Al, Ga, or In.

13. The method as claimed in claim 8, wherein the RE-containing oxide comprises oxide of Pr, Nd, Eu, Gd, Tb, Ce, Dy, Yb, Er, Sc, Mn, or Zn, or nitrate of Pr, Nd, Eu, Gd, Tb, Ce, Dy, Yb, Er, Sc, Mn, or Zn.

14. The method as claimed in claim 8, wherein the RE′-containing oxide comprises oxide of Pr, Nd, Gd, Tb, Ce, Dy, Yb, Er, Bi, or nitrate of Pr, Nd, Gd, Tb, Ce, Dy, Yb, Er, Bi.

15. A light emitting device, comprising:
an excitation light source; and
the phosphor as claimed in claim 1.

16. The light emitting device as claimed in claim 15, wherein the excitation light source comprises a blue or ultraviolet light emitting diode (LED), a laser diode (LD), a vacuum ultraviolet (VUV), or Hg vapor arc.

17. The light emitting device as claimed in claim 15, wherein the light emitting device is a germicidal lamp.

18. The light emitting device as claimed in claim 15, wherein the light emitting device comprises an external electrode fluorescent lamp (EEFL), a liquid crystal display (LCD), an organic light emitting diode (OLED), a plasma display panel (PDP), a light emitting diode (LED) device, a excimer lamp, or a cold cathode fluorescent lamp (CCFL).

19. The light emitting device as claimed in claim 18, further comprising:
a yellow phosphor.

20. The light emitting device as claimed in claim 19, wherein the yellow phosphor comprises Y₃Al₅O₁₂:Ce³⁺ (YAG), Tb₃Al₅O₁₂:Ce³⁺ (TAG), (Ca,Mg,Y)Si_{w}AlₓO_{y}N_{z}:Eu²⁺ or (Mg,Ca,Sr,Ba)₂SiO₄:Eu²⁺.

21. The light emitting device as claimed in claim 18, further comprising:
a red phosphor.

22. The light emitting device as claimed in claim 21, wherein the red phosphor comprises (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺⁺, (Ca,Sr,Ba)₂Si₅N₈:Eu²⁺, (Ca,Sr)AlSiN₃:Eu²⁺, Sr₃SiO₅:Eu²⁺, Ba₃MgSi₂O₈:Eu²⁺,Mn²⁺, Ca₂Si₅N₈:Eu²⁺ or ZnCdS:AgCl.

23. The light emitting device as claimed in claim 18, further comprising:
a blue phosphor.

24. The light emitting device as claimed in claim 23, wherein the blue phosphor comprises BaMgAl₁₀O₁₇:Eu²⁺, (Sr,Ca,Ba,Mg)₅(PO₄)₃Cl:Eu²⁺, Ca₂PO₄Cl:Eu²⁺, Sr₂Al₆O₁₁:Eu²⁺, or CaAl₂O₄:Eu²⁺.

25. The light emitting device as claimed in claim 18, further comprising:
a green phosphor and a red phosphor.

26. The light emitting device as claimed in claim 25, wherein the green phosphor comprises BaMgAl₁₀O₁₇:Eu²⁺,Mn²⁺ (BAM-Mn), SrSi₂N₂O₂:Eu²⁺, CaSc₂O₄:Ce³⁺, Ca₃Sc₂Si₃O₁₂:Ce³⁺, (Ca,Sr,Ba)₄Al₁₄O₂₅:Eu²⁺, Ca₈Mg(SiO₄)₄Cl₂:Eu²⁺, Mn²⁺, or (Ba,Sr)₂SiO₄:Eu²⁺.
